(19) United States
(12) Patent Application Publication
(10) Pub. No.: US 2025/0333856 A1
(43) Pub. Date: Oct. 30, 2025

(54) MEA FOR CARBON DIOXIDE REDUCTION INCLUDING REDUCTION CATALYST LAYER CATHODE OF DOUBLE-LAYER STRUCTURE, ASSEMBLY FOR CARBON DIOXIDE REDUCTION INCLUDING THE MEA, AND METHOD FOR PREPARING THE MEA

(71) Applicant: KOREA INSTITUTE OF SCIENCE AND TECHNOLOGY, Seoul (KR)

(72) Inventors: Woong-Hee LEE, Seoul (KR); Hyung-Suk OH, Seoul (KR); Byoung-Koun MIN, Seoul (KR); Da-Hye WON, Seoul (KR); Ung LEE, Seoul (KR); Dong-Ki LEE, Seoul (KR); Jai-Hyun KOH, Seoul (KR); Chan-Sol KIM, Seoul (KR); Jae-Yong PARK, Seoul (KR)

(21) Appl. No.: 18/897,850

(22) Filed: Sep. 26, 2024

(30) Foreign Application Priority Data
Apr. 25, 2024 (KR) 10-2024-0055384

(51) Int. Cl. C25B 9/23; C25B 11/032; C25B 11/052; C25B 11/081; C25B 13/08

(52) U.S. Cl. CPC C25B 9/23; C25B 11/032; C25B 11/052; C25B 11/081; C25B 13/08

(57) ABSTRACT

Embodiments relate to a technology for a membrane electrode assembly (MEA) for carbon dioxide reduction. In particular, the embodiments relate to a technology capable of changing an acidic environment, which is unfavorable to a reaction on the cathode side during a catalytic reaction, into an alkaline environment, which is a problem when a cation exchange membrane is used as a separation membrane, as well as reducing the hydrogen evolution reaction (HER), which is a side reaction.

### CROSS-REFERENCE TO RELATED APPLICATION

This application claims the priority of Korean Patent Application No. 10-2024-0055384 filed on Apr. 25, 2024, in the Korean Intellectual Property Office, the disclosure of which is incorporated herein by reference.

### BACKGROUND

### 1. Field of the Invention

The present disclosure relates to a technology for a membrane electrode assembly (MEA) including a cation exchange membrane, a method for preparing the MEA, and an assembly for carbon dioxide reduction including the MEA, and more particularly, to a novel technology capable of solving problems occurring when applying a cation exchange membrane by improving a cathode catalyst layer.

### 2. Description of the Related Art

As the use of fossil fuels increases, global warming is worsening due to the increasing amount of carbon dioxide, and research is continuously being conducted to solve this problem.

The electrochemical CO₂ reduction reaction (abbreviated as “CO₂RR”) is attracting attention as a method for reducing carbon dioxide and converting carbon dioxide into high value-added compounds such as carbon monoxide and ethylene. CO₂RR technology using cation or anion exchange membranes is attracting attention due to low resistance and high scalability between electrodes.

Over the past several decades, there has been significant progress in the development of CO₂RR electrode assemblies using anion exchange membranes, and electrode assemblies using anion exchange membranes are widely known as assemblies for converting CO₂ into useful substances such as carbon monoxide and ethylene with high selectivity and current density. However, the anions such as HCO₃⁻, CO₂²⁻, etc., and the liquid products of CO₂RR generated in the CO₂RR process using an anion exchange membrane cross-over through the anion exchange membrane, so there is a limit to the CO₂ conversion rate, and the anion exchange membrane has low mechanical and chemical stability, so there is a problem that the possibility of industrialization is low. In addition, the CO₂RR electrode assembly using the anion exchange membrane has a disadvantage in that an additional process including capture and reuse of CO₂ is required on the anode side due to the cross-over of CO₂.

Recently, electrode assemblies (MEAs) using cation exchange membranes (CEMs), such as Nafion®, are preferred to overcome the limitations of anion exchange membranes (AEMs). CEMs are widely used in electrochemistry due to their high stability and proton conductivity, but there is a problem in that, while it is advantageous to maintain an alkaline state on the cathode side during the reduction reaction for CO₂ reduction, the high proton conductivity of the CEM induces an acidic reaction environment on the cathode side, which reduces the selectivity of CO₂RR and promotes the hydrogen evolution reaction (HER).

### SUMMARY

An object of the present disclosure is to provide a technology that may suppress HER, which is a problem that occurs when using a CEM in CO₂RR, and exhibit high carbon dioxide conversion efficiency.

In addition, an object of the present disclosure to provide an electrode structure for an electrode assembly of a cation ion exchange membrane having a high CO₂RR Faraday efficiency.

To achieve the above object, the present disclosure provides an MEA for CO₂ reduction including: a cathode including a gas diffusion layer (GDL) and a catalyst layer; a cation exchange membrane (CEM); and an anode layer including an oxidation catalyst, wherein the catalyst layer of the cathode layer includes a first layer including a reduction catalyst and an anion exchange ionomer formed on the GDL; and a second layer including a carbon-based mixture and an anion exchange ionomer formed on the first layer.

In particular, the reduction catalyst may be any one or more selected from Ag, Au, Zn, Cu and In.

In particular, the reduction catalyst may be used in a content of 0.5 mg/cm² to 3 mg/cm².

In particular, a particle size of the reduction catalyst may be in a form of nanoparticles of 10 nm or less, in a form of secondary particles in which the nanoparticles are agglomerated, in a form of single particles having an average particle diameter of 0.01 to 2 μm, or in a form of a mixture thereof.

In particular, the carbon-based mixture may be at least one or more of carbon black, carbon nanotubes, graphene, carbon nanofibers, and graphitized carbon black.

In particular, the carbon-based mixture may be contained in an amount of 20 to 300 parts by weight based on 100 parts by weight of the reduction catalyst.

In particular, the anion exchange ionomer may be contained in an amount of 50 to 1000 parts by weight based on 100 parts by weight of the reduction catalyst.

In addition, the present disclosure provides an assembly for CO₂ reduction, applying the MEA.

In addition, the present disclosure provides a method for preparing an MEA for CO₂reduction, including: preparing a gas diffusion layer; preparing a first layer by coating a mixed solution of a reduction catalyst, an anion exchange ionomer, and a solvent on the gas diffusion layer; and preparing a second layer by coating a mixed solution of a carbon-based mixture and an anion exchange ionomer on the first layer to prepare a cathode layer, and thereafter, laminating a cation exchange membrane and an anode layer on the cathode layer.

In particular, each of the preparing of the first layer and the preparing of the second layer may include a drying process.

An MEA using a CEM according to the present disclosure has high current density and selectivity, and thus may be effectively utilized in a carbon dioxide reduction reaction (CO2RR) system.

As in the present disclosure, when the carbon-based support exists in a layered structure separately from the reduction catalyst, it may be found that more cations (K⁺) exist in the electrode. It may be found that the layered structure of the double-layer structure with the same components as in the Example of the present disclosure is more advantageous in preserving cations (K⁺) than the mixed structure of the same components of Comparative Example 3.

In addition, when the MEA of the present disclosure was applied, the movement of water was almost suppressed, but the catalyst prepared in Comparative Example 1 had a problem of being completely wetted by the moved water.

In addition, it may be found that, when a mixture of carbon and anion ionomer is present in the buffer layer as in the present disclosure, the Faraday efficiency of carbon monoxide is the highest, and as in Comparative Example 1, even when a buffer layer is present, the Faraday efficiency of carbon monoxide decreases rapidly at high currents.

In addition, in the case where there is no catalyst structure buffer layer of Comparative Example 2, H⁺ is transferred from the CEM, increasing the acidity near the silver nano catalyst, thereby increasing the HER. In the case where a buffer layer composed only of anion exchange ionomer is present in the catalyst structure of Comparative Example 1, the anions generated in the carbon dioxide reduction reaction and H⁺ transferred from the CEM react in the buffer layer to regenerate carbon dioxide and maintain the area around the silver nano catalyst in a neutral state. However, CO₂RR decreases at high currents due to low cation (K⁺) concentration. On the other hand, when a buffer layer composed of an anion exchange ionomer and a carbon black mixture is present in the catalyst structure of the present disclosure, the porous carbon structure promotes the regeneration of carbon dioxide by reacting anions generated from CO₂RR and H⁺ transferred from the CEM in the buffer layer, and maintains CO₂R performance to some extent at high current due to the high cation (K⁺) concentration.

When using the electrode catalyst of the present disclosure, it may be found that the performance of CO₂RR is maintained at a high current density (300 mA cm⁻²) at a pressure of 1 bar, and when the pressure is applied up to 5 bar, it may be found that CO₂RR is dominant over the hydrogen reaction up to 350 mA cm⁻².

### BRIEF DESCRIPTION OF THE DRAWINGS

FIG. 1 is a schematic diagram for explaining differences according to structures of electrode catalysts prepared in Example and Comparative Examples 1 to 3.

FIG. 2 shows scanning electron microscope (SEM) images and energy dispersive spectroscopy (EDS) images of electrode catalysts prepared in Example and Comparative Examples 1 to 3 after a carbon dioxide conversion reaction.

FIG. 3 shows results of in-situ micro computed tomography of electrode catalysts prepared in Example and Comparative Example 1.

FIGS. 4A and 4B illustrate voltage (FIG. 4A) and Faraday efficiency (FIG. 4B) of a product according to structures of electrode catalysts prepared in Example and Comparative Examples 1 to 3.

FIG. 5 illustrates reaction environment of catalysts prepared in Example, Comparative Example 1, and Comparative Example 2.

FIG. 6 illustrates a system for pressurizing CO₂ in an electrode assembly using an electrode catalyst and a cation membrane prepared in Example.

FIG. 7A shows results of measuring Faraday efficiency of carbon monoxide and hydrogen according to pressure using a pressurized carbon dioxide conversion apparatus and pressurized electrolytic cell schematized in FIG. 6 for a catalyst electrode prepared in Comparative Example 1, and FIG. 7B shows results for a catalyst electrode prepared in the Example.

FIG. 8 shows carbon monoxide Faraday efficiency measured using a carbon dioxide conversion apparatus at atmospheric pressure and 5 bar pressure for catalyst electrodes prepared in Example and Comparative Example 1, respectively.

### DETAILED DESCRIPTION

The present disclosure is characterized in that, in an MEA for CO₂ reduction including a cathode layer including a gas diffusion layer (GDL) and a catalyst layer; a cation exchange membrane (CEM); and an anode layer including an oxidation catalyst, the catalyst layer of the cathode layer includes a first layer including a reduction catalyst and an anion exchange ionomer formed on the GDL; and a second layer including a carbon-based mixture and an anion exchange ionomer formed on the first layer.

In the present disclosure, a CEM is used, and a technology for improving a cathode layer is disclosed to solve a problem that occurs due to acidification of the cathode side during the reaction, which is a problem when using a CEM. The cathode layer is identical to the prior art in that it includes a gas diffusion layer (GDL) and a catalyst layer. The present disclosure is characterized in that, in addition to the reduction catalyst, the catalyst layer further includes a carbon-based mixture and an anion exchange ionomer, and has a double-layer structure.

Hereinafter, the present disclosure will be described with reference to the drawings.

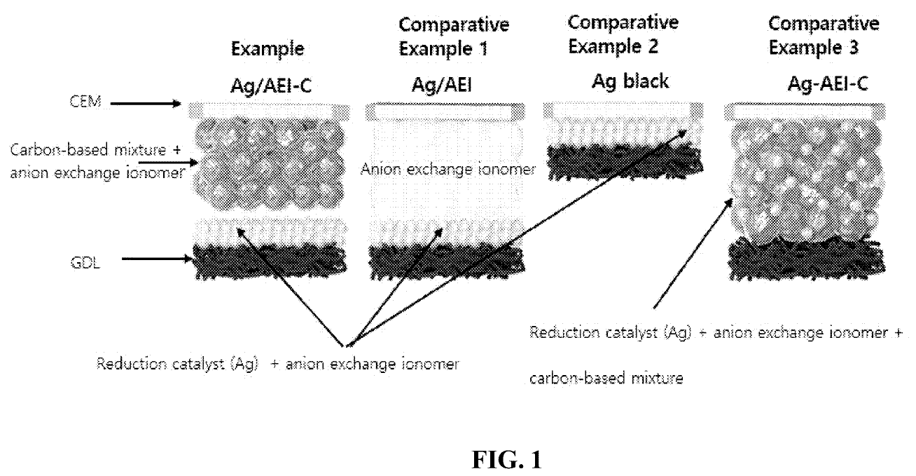

FIG. 1 is a diagram explaining cathode structures of the present disclosure (Example) and Comparative Examples 1 to 3.

Referring to FIG. 1, the present disclosure is formed as a double-layer including a first layer including a reduction catalyst and an anion exchange ionomer formed on the GDL; and a second layer including a carbon-based mixture and an anion exchange ionomer formed on the first layer.

Here, the first layer may be prepared by applying and drying a mixture solution of a reduction catalyst, for example, silver nanoparticles and anion exchange ionomer, on the GDL, and at this time, the temperature may be increased after application to evaporate the solvent, thereby preparing the first layer.

Meanwhile, the second layer may be prepared by applying and drying a mixed solution of a carbon precursor and an anion exchange ionomer on the first layer, and the second layer may also be prepared by increasing the temperature after application to evaporate the solvent.

Meanwhile, Comparative Example 1 has a double-layer structure of a first layer of a reduction catalyst and an anion exchange ionomer on a GDL and an anion exchange ionomer layer formed on the first layer, and unlike Example of the present disclosure, the second layer does not contain a carbon-based mixture. Comparative Example 2 is a single-layer structure of a reduction catalyst and an anion exchange ionomer on a GDL. Comparative Example 3 is a single-layer structure of a reduction catalyst, a carbon-based mixture, and an anion exchange ionomer.

A carbon dioxide reduction apparatus including the MEA of the present disclosure is formed by combining the MEA with a carbon dioxide supply unit on the cathode side and a water supply unit on the anode side. The carbon dioxide reduction apparatus using the MEA of the present disclosure may produce carbon monoxide through a carbon dioxide reduction reaction by performing an oxygen generation reaction through water electrolysis on the anode side and flowing humidified carbon dioxide gas on the cathode side. The carbon dioxide reduction apparatus has high selectivity by applying an electrode catalyst for carbon dioxide reduction suitable for a CEM. In the carbon dioxide reduction apparatus, a catalyst that is advantageous for oxygen generation reaction, such as iridium oxide, is applied to a metal mesh and used as the anode. In the present disclosure, a CEM is used between the two electrodes to prevent products generated at the anode and cathode from mixing.

The membrane electrode assembly (MEA), which is an assembly of an anode, cathode, and membrane for carbon dioxide reduction, is a well-known technology, so a detailed description of each component will be omitted.

Each component is described in detail below.

### Reduction catalyst

The reduction catalyst typically uses metal nanoparticles, and the metal nanoparticles have a catalytic activity capable of reducing carbon dioxide, and may include, but are not limited to, one or more selected from gold (Au), silver (Ag), zinc (Zn), copper (Cu), indium (In), and alloys thereof. For example, the metal nanoparticles may be silver nanoparticles. Silver (Ag) may reduce carbon dioxide to produce carbon monoxide with high selectivity and current density. The content of the metal nanoparticles may be applied in a range of 0.5 mg/cm² to 3 mg/cm² per unit area of the GDL. The metal nanoparticles may be distributed in the form of very small nanoparticles of about 10 nm or less, for example, 1 to 10 nm, or may be in the form of secondary particles in which these nanoparticles are agglomerated, or may be in the form of single particles having an average particle diameter of 0.01 to 2 μm, or may have a form in which these are mixed. For example, metal particles may exist on the surface of a carbon-based mixture as small particles of several nanometers or less, while secondary particles formed by agglomeration of nanoparticles may be mixed. The average particle size of the agglomerated secondary particles may be, for example, in the range of 0.05 to 1.5 μm, specifically, for example, in the range of 0.1 to 1 μm. The form of the metal nanoparticles is not limited thereto and may exist in any form.

### Carbon-Based Mixture

The carbon-based mixture may include, for example, at least one selected from carbon black, carbon nanotubes, graphene, carbon nanofibers, and graphitized carbon black. In particular, carbon black may be used as a carbon-based mixture to help improve current density. In the present disclosure, the carbon-based mixture may increase the thickness of the electrode catalyst layer, thereby increasing the pH of the electrode, thereby improving the carbon dioxide reduction efficiency. In the present disclosure, the content of the carbon-based mixture may be used in a range of 20 to 300 parts by weight based on 100 parts by weight of metal nanoparticles, which are reduction catalysts. In the above range, the carbon-based mixture mixed with metal nanoparticles may effectively increase the thickness of the metal nanoparticle layer, thereby maintaining a high pH and exhibiting high CO₂RR selectivity.

In the present disclosure, the carbon-based mixture may be formed by mixing with the nanoparticle reduction catalyst with a solvent and then coating it on the GDL.

### Anion Exchange Ionomer

The anion exchange ionomer may wrap around the metal particle and cover the surface of the metal particle. The content of the anion exchange ionomer may be in the range of 20 to 300 parts by weight based on 100 parts by weight of metal nanoparticles. In the above range, the anion exchange ionomer mixed with the metal nanoparticles may effectively wrap the surface of the metal nanoparticles and suppress the transfer of hydrogen ions (H⁺), thereby exhibiting high CO₂RR selectivity.

Examples of anion exchange ionomers include XA-9, XC-1, XC-2 anionic ionomers from Dioxide, FAA-3 anionic ionomer from Fumatech, PiperiON anionic ionomer, quaternary ammonium based polymers, imidazolium based polymers, etc.

Exemplary implementation examples are described in more detail through the following Example and Comparative Examples. Example and Comparative Examples 1 to 3 were prepared with the same structure as FIG. 1. However, Example and Comparative Examples are intended to illustrate technical ideas and the scope of the present disclosure is not limited thereto.

### Example: Preparation of Silver Nanoparticles, Anion Exchange Ionomer, and Carbon Support Mixed Layered Electrode (Denoted as Ag/AEI-C)

Silver nanoparticles (average particle size of 20-40 nm) were used as a reduction catalyst for the cathode. 30 mg of silver nanoparticles and 15 mg of anion exchange ionomer (abbreviated as AEI, XA-9 from Dioxide, same in the following experiment) were dissolved in 2 mL of ethanol and sonicated for about 20 minutes to prepare a well-dispersed solution. The solution was applied to a GDL (Fuelcellstore, Sigracet 39BC) with an MPL layer so as to have 1 mg of silver nanoparticles per cm2, and then heated to 70° C. to rapidly dry the solution, thereby producing a first layer.

15 mg of carbon black (KB600J) and 75 mg of AEI were dissolved in 2 ml of ethanol and sonicated for approximately 20 minutes to prepare a well-dispersed solution. The solution was applied on the first layer so as to have 0.5 mg of carbon black per cm², and then heated to 70° C. to rapidly dry the solution, thereby forming a second layer on the first layer, thereby producing a catalyst layer of a double-layer structure.

### Comparative Example 1: Preparation of Silver Nanoparticle, AEI Layered Electrode (Denoted as Ag/AEI)

30 mg of silver nanoparticles and 15 mg of AEI were dissolved in 2 mL of ethanol and sonicated for about 20 minutes to prepare a well-dispersed solution. The solution was applied to a GDL (Fuelcellstore, Sigracet 39BC) with an MPL layer so as to have 1 mg of silver nanoparticles per cm², and then heated to 70° C. to rapidly dry the solution, thereby producing a catalyst electrode.

Afterwards, an ethanol solution containing 5 wt % of AEI was applied on the catalyst layer prepared above so as to have 2.5 mg of AEI per cm², and then heated to 70° C. to rapidly dry the solution, thereby producing a catalyst electrode.

### Comparative Example 2: Preparation of AEI Mixed Silver Nanoparticle Electrode (Denoted as Ag Black)

A catalyst in which 30 mg of silver nanoparticles and 15 mg of AEI are mixed was sonicated in 2 mL of ethanol to prepare a well-dispersed solution. As in Example, the solution was applied to a GDL so as to have 1 mg per cm², and then heated to 90° C. to rapidly dry the solution, thereby preparing a catalyst electrode.

### Comparative Example 3: Preparation of Silver Nanoparticles, AEI, and Carbon Mixed Electrode (Denoted as Ag-AEI-C)

30 mg of silver nanoparticles, 15 mg of carbon black (KB600J), and 90 mg of AEI were dissolved in 3 ml of ethanol and sonicated for about 20 minutes to prepare a well-dispersed solution. The solution was applied to a GDL (Fuelcellstore, Sigracet 39BC) with an MPL layer so as to have 1 mg of silver nanoparticles per cm2, and then heated to 70° C. to rapidly dry the solution, thereby preparing a catalyst electrode.

The following experiments were conducted using the cathodes of Examples and Comparative Examples 1 to 3.

### Experimental Example 1: SEM Evaluation

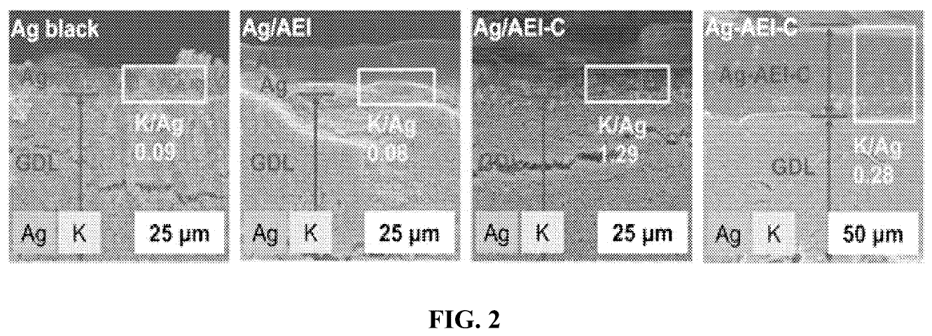

FIG. 2 shows scanning electron microscope (SEM) images and energy dispersive spectroscopy (EDS) analysis results of electrode catalysts prepared in Example and Comparative Examples 1 to 3 after a reaction.

As shown in FIG. 2, when comparing Example and Comparative Example 1, it was found that more cations (K⁺, electrolyte) were present in the electrode when the carbon-based support exists in a layered structure as in the present disclosure. In addition, when comparing Example with Comparative Example 3, it was found that a double-layer layered structure with the same components as in the present disclosure is more advantageous in preserving cations (K⁺) than a mixed structure with the same components.

### Experimental Example 2: Micro CT Evaluation

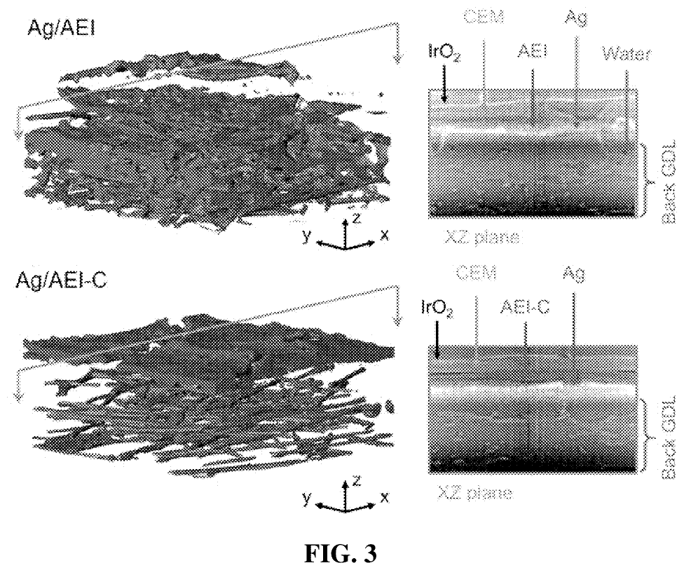

FIG. 3 shows results of analysis using micro computed tomography of electrode catalysts prepared in Example and Comparative Example 1 after the reaction.

As shown in FIG. 3, it was found that the catalyst prepared in Example had almost no movement of water, but the catalyst prepared in Comparative Example 1 was completely wet by the moved water.

### Experimental Example 3: Evaluation of Carbon Dioxide Conversion Performance at Atmospheric Pressure

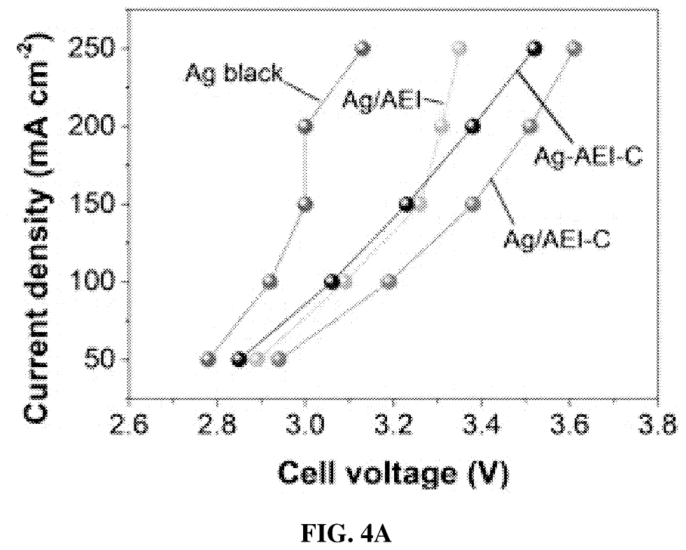

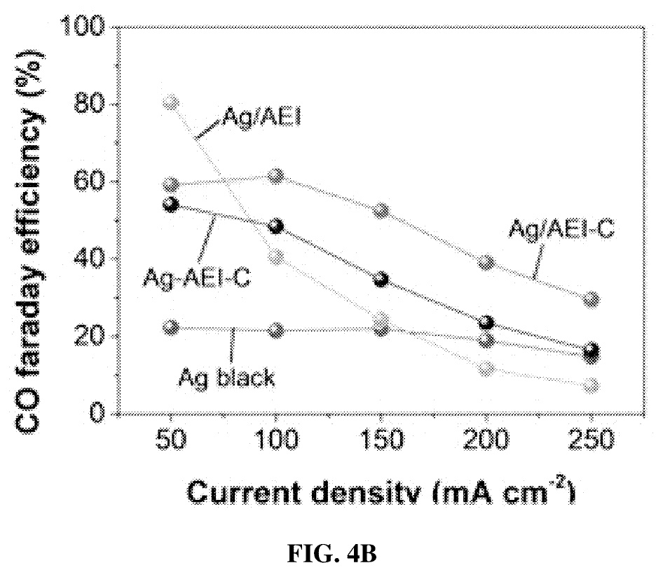

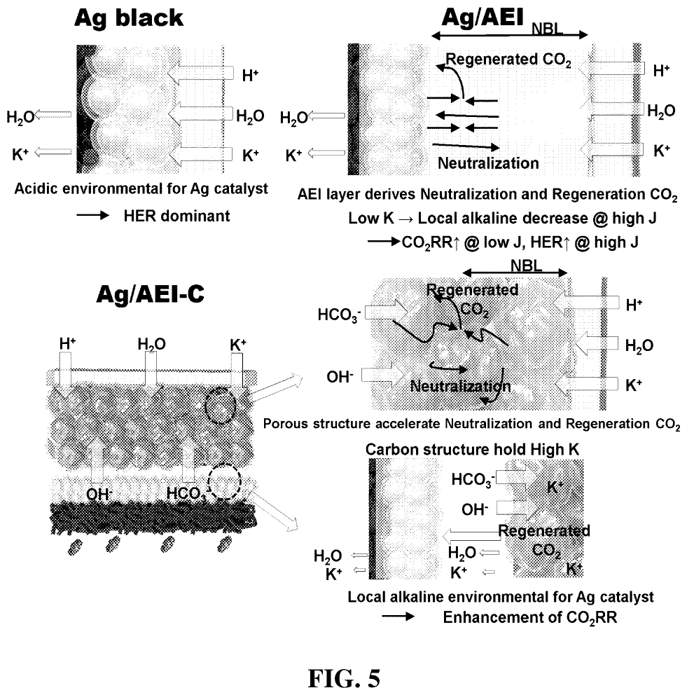

FIGS. 4A and 4B show current-voltage (FIG. 4A) according to electrode structures and Faraday efficiency of carbon monoxide (FIG. 4B) according to an amount of carbon-based support to check carbon dioxide conversion-carbon monoxide production performance of electrode catalysts prepared in Example and Comparative Examples 1 to 3. The system at this time used a Nafion 211 CEM, and IrO₂ was applied onto a Pt-coated Ti mesh as the anode catalyst. The electrolyte was 0.05 M KHCO₃, which was passed through the anode, and 50 ccm of carbon dioxide was passed through the cathode. FIG. 5 illustrates reaction environment of catalysts prepared in Example, Comparative Example 1, and Comparative Example 2.

As shown in FIG. 4A, it was found that the voltage increased at the same current when a buffer layer was present in the catalyst structure.

As shown in FIG. 4B, it was found that the Faraday efficiency of carbon monoxide was high in the order of Ag/AEI-C of Example, Ag-AEI-C of Comparative Example 3, Ag/AEI of Comparative Example 1, and Ag black of Comparative Example 2. It may be found that the Faraday efficiency of carbon monoxide was the highest when a mixture of carbon and anion ionomer was present in the buffer layer as in the present disclosure, and when there was no carbon-based mixture as in Comparative Example 1, the Faraday efficiency of carbon monoxide decreased rapidly at high current even when a buffer layer was present.

As shown in FIG. 5, in the case where the catalyst structure buffer layer of Comparative Example 2 was absent, H⁺ was transferred from the CEM, increasing the acidity near the silver nano catalyst, thereby increasing the HER. In the case where a buffer layer composed only of an AEI was present in the catalyst structure of Comparative Example 1, the anions generated in the carbon dioxide reduction reaction and the H⁺ transferred from the CEM reacted in the buffer layer to regenerate carbon dioxide and maintain the area around the silver nano catalyst in a neutral state. However, CO₂RR decreased at high currents due to low cation (K⁺) concentration. On the other hand, in the case where a buffer layer composed of an AEI and a carbon black mixture was present in the catalyst structure of Example of the present disclosure, the anions generated from CO₂RR and H⁺ transferred from the CEM reacted in the buffer layer, so the porous carbon structure promoted the regeneration of carbon dioxide, and the CO₂RR performance was maintained to some extent at high currents due to the high cation (K⁺) concentration.

### Experimental Example 4: Evaluation of Carbon Dioxide Conversion Performance According to Pressure

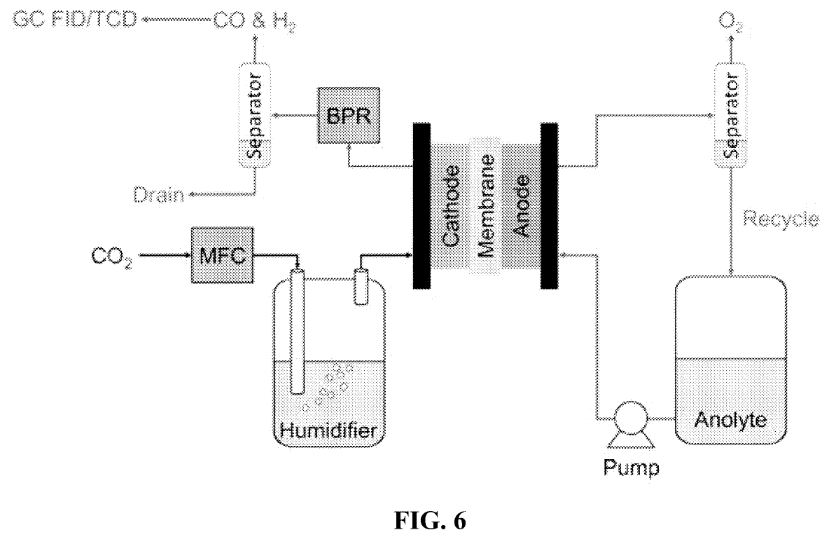

FIG. 6 illustrates a system for pressurizing CO₂ in an electrode assembly using an electrode catalyst and a cation membrane prepared in Example.

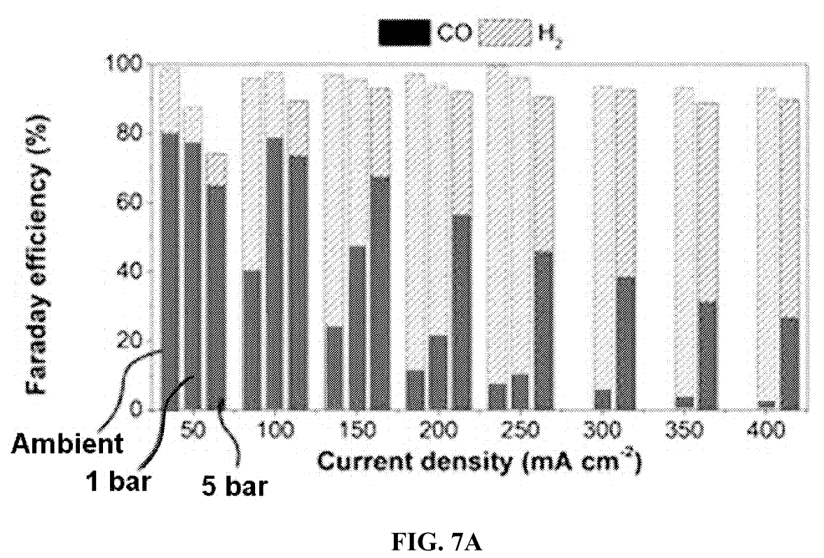

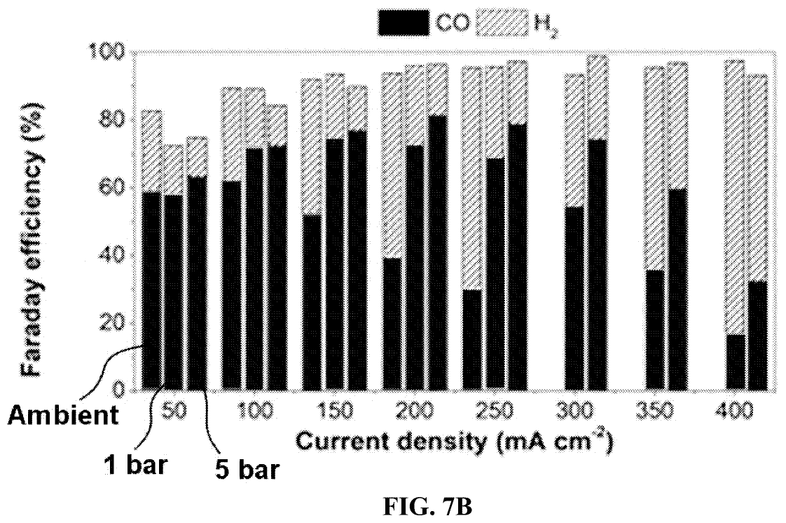

FIG. 7A shows results of measuring Faraday efficiency of carbon monoxide and hydrogen according to pressure using a pressurized carbon dioxide conversion apparatus and pressurized electrolytic cell schematized in FIG. 6 for a catalyst electrode prepared in Comparative Example 1, and FIG. 7B shows results for a catalyst electrode prepared in the Example.

As shown in FIG. 7A, it was found that the Faraday efficiency of carbon monoxide increased as the pressure increased when the electrode catalyst of Comparative Example 1 was used. However, it was found that the HER became a dominant reaction over CO₂RR when the current density applied at 5 bar exceeded 250 mA cm⁻².

As shown in FIG. 7B, it was found that the performance of CO₂RR was maintained at a high current density (300 mA cm⁻²) at a pressure of 1 bar when the electrode catalyst of Example was used. In addition, when the pressure was applied up to 5 bar, it was found that CO₂RR was dominant over the hydrogen reaction up to 350 mA cm⁻².

### Experimental Example 5: Electrode Catalyst Durability Evaluation

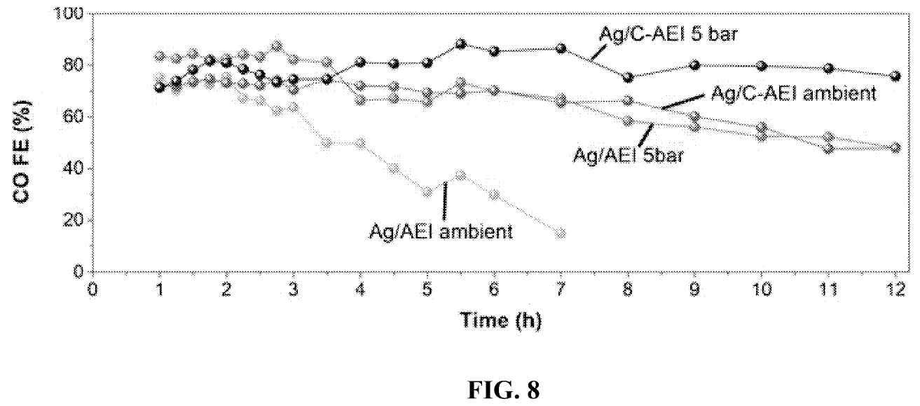

FIG. 8 shows carbon monoxide Faraday efficiency measured using a carbon dioxide conversion apparatus at atmospheric pressure and 5 bar pressure for catalyst electrodes prepared in Example and Comparative Example 1, respectively.

In Experimental Example 5, a durability evaluation was conducted, and conditions were set to constantly flow a current of 100 mA/cm². A Pt-coated Ti mesh applied with IrO₂ was used as the anode catalyst. The electrolyte was 0.05 M KHCO₃, which was passed through the anode, and 50 ccm of carbon dioxide was passed through the cathode. The electrode catalyst of Comparative Example 1 maintained a Faraday efficiency of 70% for 3 hours at atmospheric pressure, but then dropped sharply to 10% after 7 hours. On the other hand, the electrode catalyst of Example maintained a Faraday efficiency of 70% for 6 hours at atmospheric pressure and then gradually dropped to 50% after 12 hours. The electrode catalyst of Comparative Example 1 maintained a Faraday efficiency of 80% for 4 hours at 5 bar, but then gradually dropped to 50% after 12 hours. On the other hand, it was found that the electrode catalyst of Example maintained a Faraday efficiency of 80% for 12 hours at 5 bar.

Although preferred embodiments of the present disclosure have been described above with reference to the drawings and examples, these are merely exemplary, and those skilled in the art will understand that various modifications and equivalent other embodiments are possible. Accordingly, the scope of protection of the present disclosure should be defined by the appended claims.

What is claimed is:

1. A membrane electrode assembly (MEA) for CO₂ reduction comprising a cathode layer comprising a gas diffusion layer (GDL) and a catalyst layer; a cation exchange membrane (CEM); and an anode layer comprising an oxidation catalyst,
wherein the catalyst layer of the cathode layer comprises:
a first layer comprising a reduction catalyst and an anion exchange ionomer formed on the GDL; and
a second layer comprising a carbon-based mixture and an anion exchange ionomer formed on the first layer.

2. The MEA for CO₂ reduction of claim 1, wherein the reduction catalyst is any one or more selected from Ag, Au, Zn, Cu, and In.

3. The MEA for CO² reduction of claim 1, wherein the reduction catalyst is 0.5 mg/cm² to 3 mg/cm².

4. The MEA for CO₂ reduction of claim 1, wherein a particle size of the reduction catalyst is in a form of nanoparticles of 10 nm or less, in a form of secondary particles in which the nanoparticles are agglomerated, in a form of single particles having an average particle diameter of 0.01 to 2 μm, or in a form of a mixture thereof.

5. The MEA for CO₂ reduction of claim 1, wherein the carbon-based mixture is any one or more of carbon black, carbon nanotubes, graphene, carbon nanofibers, and graphitized carbon black.

6. The MEA for CO₂ reduction of claim 1, wherein the carbon-based mixture is contained in an amount of 20 to 300 parts by weight based on 100 parts by weight of the reduction catalyst.

7. The MEA for CO₂ reduction of claim 1, wherein the anion exchange ionomer is contained in an amount of 50 to 1000 parts by weight based on 100 parts by weight of the reduction catalyst.

8. An assembly for CO₂ reduction, applying the MEA of claim 1. 15 9. A method for preparing a membrane electrode assembly (MEA) for CO₂ reduction, comprising:
preparing a gas diffusion layer;
preparing a first layer by coating a mixed solution of a reduction catalyst, an anion exchange ionomer, and a solvent on the gas diffusion layer; and
preparing a second layer by coating a mixed solution of a carbon-based mixture and an anion exchange ionomer on the first layer to prepare a cathode layer, and thereafter,
laminating a cation exchange membrane and an anode layer on the cathode layer.

10. The method of claim 9, wherein each of the preparing of the first layer and the preparing of the second layer comprises a drying process.
